(19) United States
(12) Patent Application Publication
(10) Pub. No.: US 2026/0042252 A1
(43) Pub. Date: Feb. 12, 2026

(54) SCREEN PROTECTOR STICKING METHOD, SCREEN PROTECTOR STICKING TOOL, AND SCREEN PROTECTOR PLATE ASSEMBLY

(71) Applicant: Changsha Yuanmeihong Internet Technology Co., Ltd., Changsha (CN)

(72) Inventor: Yushi TANG, Duyun (CN)

(73) Assignee: Changsha Yuanmeihong Internet Technology Co., Ltd., Changsha (CN)

(21) Appl. No.: 18/827,660

(22) Filed: Sep. 6, 2024

(30) Foreign Application Priority Data
Aug. 12, 2024 (CN) 202411101720.7

(51) Int. Cl. B29C 63/22; B29C 63/00; B29L 31/34

(52) U.S. Cl. CPC B29C 63/22; B29C 63/0004; B29C 2063/0008; B29L 2031/3437

(57) ABSTRACT

The present disclosure relates to a screen protector sticking method, a screen protector sticking tool, and a screen protector plate assembly. The screen protector sticking tool includes a main body piece, a front locating piece, a rear locating piece, and a pressing assembly. The pressing assembly includes a sliding cover, a scraper blade, and an elastic member. The sliding cover is slidably connected to the main body piece, and the scraper blade is rotatably connected to the sliding cover; the scraper blade is oblique relative to the sliding cover and gradually moves away from a first end in a direction from the sliding cover towards the main body piece; and the elastic member is arranged between the sliding cover and the scraper blade to adaptively adjust a height position of the scraper blade.

### CROSS-REFERENCE TO RELATED APPLICATIONS

The application claims priority to Chinese patent application No. 202411101720.7, filed on Aug. 12, 2024, the entire contents of which are incorporated herein by reference.

### TECHNICAL FIELD

The present disclosure relates to the technical field of electronic product accessories, and in particular, to a screen protector sticking method, a screen protector sticking tool, and a screen protector plate assembly.

### BACKGROUND

To accurately mount a screen protector on a mobile phone screen and ensure that no bubbles or dust is generated between the mobile phone screen and the screen protector in a sticking process, if a user purchases a tempered glass screen protector, a screen protector sticking tool will be designed according to external structural characteristics of the tempered glass screen protector and external structural characteristics of a mobile phone, to help more efficiently stick the external structural characteristics on the mobile phone screen.

In the prior art, a screen protector on a screen protector plate may be divided into two halves which are attached to two sides of the screen protector plate from the middle of the screen protector plate. To stick the screen protector, the screen protector on one side may be torn down first. After this screen protector is stuck to an electronic device, the screen protector plate needs to be bent from the middle, thereby tearing down the screen protector on the other side for sticking. However, this way easily generates creases on the screen protector plate and affects subsequent use by a user. In addition, the existing screen protector sticking tool are specifically designed for electronic devices of one type. Since different electronic devices have different sizes and thicknesses, and screen protector plates of different types have different thicknesses as well, heights and positions of scraper blades of the screen protector plates cannot be adjusted. As a result, the existing screen protector sticking tools can only adapt to one or several types of electronic devices, and the universality is poor.

### SUMMARY

A first objective of the present disclosure is to provide a screen protector sticking method, aiming to solve the technical problem that an existing screen protector sticking tool easily generates creases and blade lines on a screen protector plate during sticking, which affects subsequent use by a user.

To solve the above technical problem, a screen protector sticking method is provided, including the following steps:
S1: placing an electronic device in a screen protector sticking tool;
S2: locating a screen protector plate assembly on the screen protector sticking tool to enable the screen protector plate assembly to be in a tight state, wherein a gap is reserved between the screen protector plate assembly and the electronic device, and a pull handle portion of the screen protector plate assembly is arranged close to the electronic device;
S3: pulling the pull handle portion to flip over the screen protector, and separating the screen protector from a main body film in a direction from a first end towards a second end;
S4: pulling the pressing assembly to press the screen protector plate assembly, so as to move the pressing assembly from the first end to the second end; and
S5: peeling off a locating film, and taking out the electronic device.

A second objective of the present disclosure is to provide a screen protector sticking tool, applied to the screen protector sticking method described above. The screen protector sticking tool includes:
a main body piece, including an accommodating chamber, a first end, and a second end, wherein the accommodating chamber is configured to accommodate the electronic device;
a front locating piece, connected to the main body piece and arranged at the first end;
a rear locating piece, connected to the main body piece and arranged at the second end; and
a pressing assembly, wherein the pressing assembly includes a sliding cover, a scraper blade, and an elastic member; the sliding cover is slidably connected to the main body piece; the scraper blade is rotatably connected to the sliding cover; the scraper blade is oblique relative to the sliding cover and gradually moves away from the first end in a direction from the sliding cover towards the main body piece; and the elastic member is arranged between the sliding cover and the scraper blade to adaptively adjust a height position of the scraper blade.

Further, an angle between the scraper blade and an upper end surface of the sliding cover is within a range of [25°, 45°].

Further, the sliding cover includes a mounting slot; a protruding column extends out of the mounting slot; the main body piece further includes a sliding chute and an inlet slot communicated to the sliding chute; the protruding column enters the sliding chute through the inlet slot; and the protruding column cooperates with the sliding chute.

Further, the pressing assembly further includes a pull handle, and the pull handle is rotatably connected to the sliding cover.

Further, the main body piece further includes a placement slot communicated to the accommodating chamber; the placement slot is arranged close to the first end; the accommodating chamber is provided with a placement region for placing the electronic device; and a ratio of an orthographic projection area of the placement slot to an orthographic projection area of the placement region is not less than 40%.

Further, the main body piece further includes a through slot communicated to the accommodating chamber; and the through slot is arranged close to the second end.

Further, the sliding cover includes a fool-proof slot; and the front locating piece is provided with a fool-proof protrusion that cooperates with the fool-proof slot.

Further, both the front locating piece and the rear locating piece are detachably connected to the main body piece; two first locating columns are arranged on the front locating piece; two second locating columns are arranged on the rear locating piece; and a distance between the two first locating columns is different from a distance between the two second locating columns.

A third objective of the present disclosure is to provide a screen protector plate assembly, used with the screen protector sticking tool described above. The screen protector plate assembly includes:
a main body film;
a screen protector, including a sticky portion, a connecting portion, and a pull handle portion, wherein the sticky portion is stuck to a first side of the main body film; the pull handle portion and the sticky portion are connected by the connecting portion; a width of the connecting portion is less than half of a width of the sticky portion; the connecting portion has a crease; and the pull handle portion extends out of the sticky portion from the connecting portion; and
a locating film, wherein the locating film is attached to a second side of the main body film; and the locating film is provided with locating holes that cooperate with the front locating piece and the rear locating piece respectively.

The embodiments of the present disclosure have the following beneficial effects:

In an embodiment, according to the screen protector sticking method of the present disclosure, since the screen protector sticking tool cooperates with the screen protector plate assembly to achieve sticking of a screen protector to an electronic device; the screen protector plate assembly is fixed to the screen protector sticking tool; the screen protector is flipped over 180° with the pull handle portion, and the entire screen protector is then torn down; in this case, the screen protector plate assembly is fully tightened by the screen protector sticking tool, so that no creases or blade lines are generated by bending, and the impact on the subsequent use by a user is avoided.

In another embodiment, according to the screen protector sticking tool of the present disclosure, the scraper blade is oblique relative to the sliding cover; the angle of the scraper blade can be adjusted, so that the scraper blade can rotate within a range; and the angle of the scraper blade can be adaptively adjusted according to a thickness of the electronic device and a thickness of the screen protector plate when the scraper blade is used in conjunction with a spring, thereby achieving the objective of adjusting the height position of the scraper blade. The screen protector sticking tool of the present disclosure is applicable to any type of devices and screen protector plates, and ensures close fit between the scraper blade and the screen protector plate, as well as the electronic device, which is conductive to improving close fit between the screen protector plate and the electronic device, without generating gaps and bubbles.

### BRIEF DESCRIPTION OF DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some embodiments of the present disclosure, and a person of ordinary skill in the art may still derive other drawings from the accompanying drawings without creative efforts.

FIG. 1 is a flowchart of a screen protector sticking method according to an embodiment of the present disclosure;

FIG. 2 is a schematic structural diagram of a screen protector sticking tool according to an embodiment of the present disclosure;

FIG. 3 is a top view of a screen protector sticking tool according to an embodiment of the present disclosure;

FIG. 4 is a schematic structural diagram of placing a front locating piece and a rear locating piece in an accommodating chamber in a screen protector sticking tool according to an embodiment of the present disclosure;

FIG. 5 is a schematic structural diagram of a pressing assembly in a viewing angle according to an embodiment of the present disclosure;

FIG. 6 is a cross-sectional view of a pressing assembly according to an embodiment of the present disclosure;

FIG. 7 is a schematic structural diagram of a pressing assembly in another viewing angle according to an embodiment of the present disclosure;

FIG. 8 is a schematic structural diagram of removing an upper cover and a pull handle from a pressing assembly according to an embodiment of the present disclosure;

FIG. 9 is a front view of a screen protector plate assembly according to an embodiment of the present disclosure;

FIG. 10 is a cutaway view of a screen protector plate assembly according to an embodiment of the present disclosure; and

FIG. 11 is a partially enlarged diagram of part A in FIG. 10.

100: screen protector sticking tool; 110: main body piece; 111: accommodating chamber; 112: first end; 113: second end; 114: locating portion; 1141: locating slot; 115: placement slot; 116: placement region; 117: through slot; 118: sliding chute; 119: inlet slot; 130: front locating piece; 131: fool-proof protrusion 132: first locating column; 140: rear locating piece; 141: second locating column; 150: pressing assembly; 151: sliding cover; 1511: upper cover; 1511A: rotating slot; 1511B: stopper; 1512: lower cover; 1512A: bevel slot; 1512B: mounting slot; 1512C: protruding column; 1513: fool-proof slot; 152: scraper blade; 1521: rotating portion; 1522: scraper blade portion; 153: elastic member; and 154: pull handle;
200: screen protector plate assembly; 210: main body film; 220: screen protector; 221: sticky portion; 222: connecting portion; 223: pull handle portion; 230: locating film; and 231: locating hole.

### DETAILED DESCRIPTION OF THE EMBODIMENTS

To facilitate understanding the present disclosure, the present disclosure will be described more comprehensively below with reference to related accompanying drawings. Preferred embodiments of the present disclosure are provided in the accompanying drawings. However, the present disclosure can be implemented in many different forms, and are not limited to the embodiments described herein. On the contrary, these embodiments are provided to make the content disclosed in the present disclosure understood more thoroughly and comprehensively.

It should be noted that when an element is referred to as being “fixed to” another element, the element can be directly on another component or there can be a centered element. When an element is considered to be “connected” to another element, the element can be directly connected to another element or there may be a centered element. The terms “vertical”, “horizontal”, “left”, “right”, and similar expressions used herein are for illustrative purposes only.

Unless otherwise defined, all technical and scientific terms used herein have the same meaning as those commonly understood by a person skilled in the art to which the present disclosure belongs. The terms used in this specification of the present disclosure are merely intended to describe objectives of the specific embodiments, but are not intended to limit the present disclosure. The term “and/or” used herein includes any and all combinations of one or more related listed items.

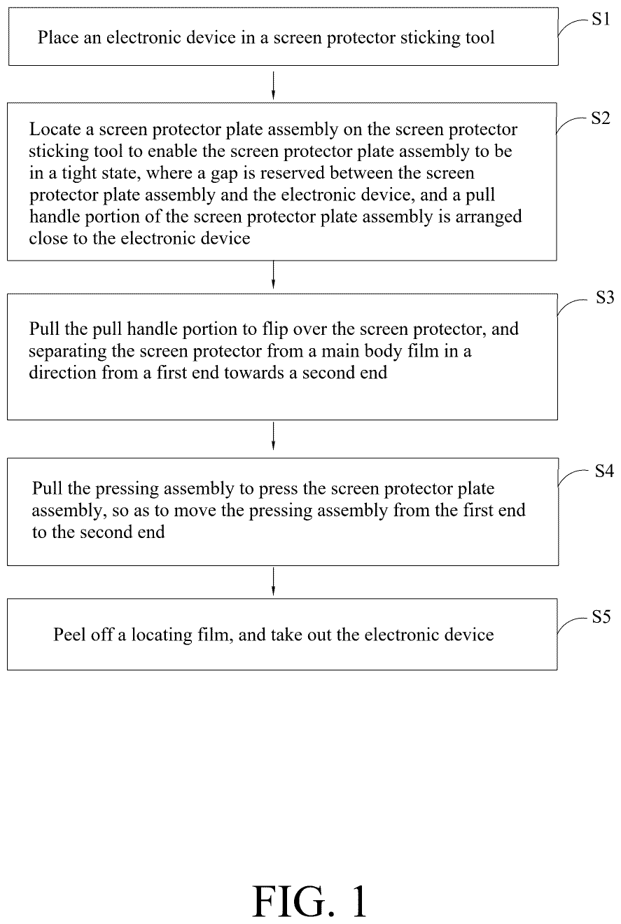

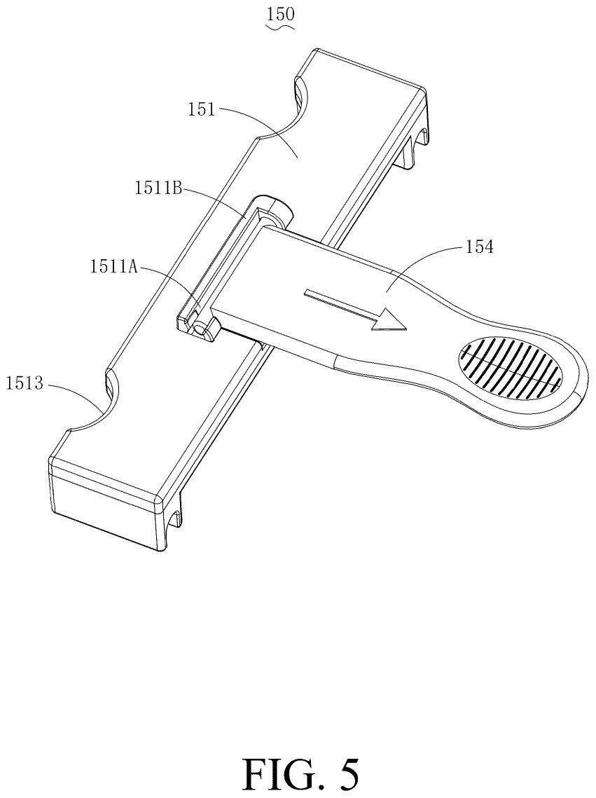

Referring to FIG. 1 to FIG. 11, an embodiment of the present disclosure provides a screen protector sticking method, including the following steps:
S1: An electronic device is placed in a screen protector sticking tool 100. Exemplarily, the screen protector sticking tool 100 of the present disclosure is applicable to a mobile phone.
S2: A screen protector plate assembly 200 is located on the screen protector sticking tool 100 to enable the screen protector plate assembly 200 to be in a tight state, wherein a gap is reserved between the screen protector plate assembly 200 and the electronic device, and a pull handle portion 223 of the screen protector plate assembly 200 is arranged close to the electronic device. Exemplarily, a gap is reserved between the screen protector plate assembly 200 and a mobile phone screen, to provide an enough space for subsequently tearing down a screen protector 220.
S3: The pull handle portion 223 is pulled to flip over the screen protector 220, and the screen protector is separated from a main body film 210 in a direction from a first end 112 towards a second end 113. Exemplarily, the pull handle portion 223 pulls the screen protector 220 to flip over 180° and then be torn down reversely, so that the screen protector 220 is separated from the main body film 210.
S4: The pressing assembly 150 is pulled to press the screen protector plate assembly 200, so as to move the pressing assembly 150 from the first end 112 to the second end 113. Exemplarily, during the execution of step S1, step S2, and step S3, the pressing assembly 150 is not mounted on the main body piece 110. After the completion of the execution of step S3, before the execution of step S4, the pressing assembly 150 needs to be mounted on the main body piece 110, and the pressing assembly 150 is then pulled.
S5: A locating film 230 is torn off, and the electronic device is taken out.

In this embodiment, according to the screen protector sticking method of the present disclosure, since the screen protector sticking tool 100 cooperates with the screen protector plate assembly 200 to achieve sticking of a screen protector to an electronic device; the screen protector plate assembly 200 is fixed to the screen protector sticking tool 100; the screen protector 220 is flipped over 180° with the pull handle portion 223, and the entire screen protector is then torn down; and in this case, the screen protector plate assembly 200 is fully tightened by the screen protector sticking tool 100, so that no creases or blade lines are generated by bending, and the impact on the subsequent use by a user is avoided.

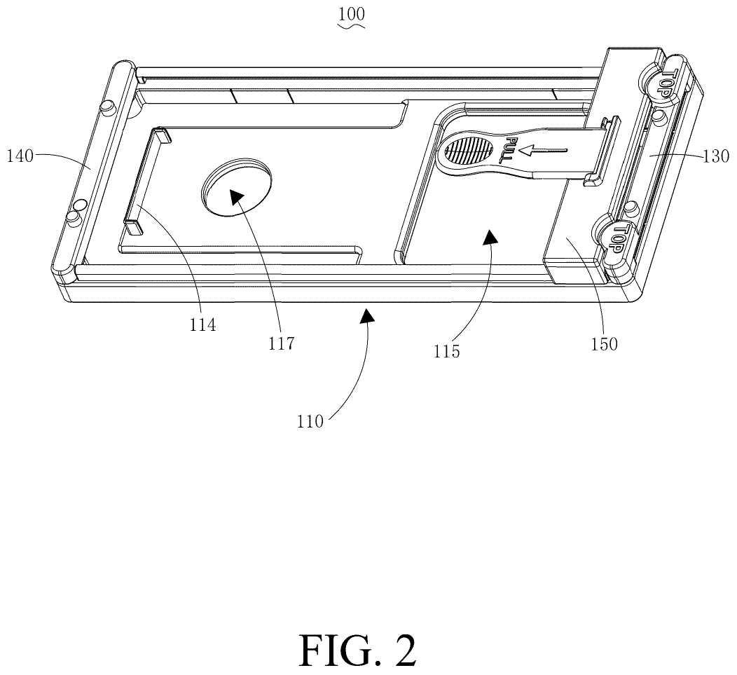

Referring to FIG. 2 to FIG. 8, a second objective of the present disclosure is to provide a screen protector sticking tool 100, applied to the screen protector sticking method described above, including a main body piece 110, a front locating piece 130, a rear locating piece 140, and a pressing assembly 150. The main body piece 110 includes an accommodating chamber 111, a first end 112, and a second end 113; the accommodating chamber 111 is configured to accommodate an electronic device; a front locating piece 130 is connected to the main body piece 110 and is arranged at the first end 112; the rear locating piece 140 is connected to the main body piece 110 and is arranged at the second end 113; the pressing assembly 150 includes a sliding cover 151, a scraper blade 152, and an elastic member 153; the sliding cover 151 is slidably connected to the main body piece 110; the scraper blade 152 is rotatably connected to the sliding cover 151; the scraper blade 152 is oblique relative to the sliding cover 151 and gradually moves away from the first end 112 in a direction from the sliding cover 151 towards the main body piece 110; and the elastic member 153 is arranged between the sliding cover 151 and the scraper blade 152 to adaptively adjust a height position of the scraper blade 152. Exemplarily, the sliding cover 151 includes an upper cover 1511 and a lower cover 1512. The upper cover 1511 is fixedly mounted on the lower cover 1512. A bevel slot 1512A is provided on the lower cover 1512. The upper cover 1511 and the lower cover 1512 are enclosed to form an accommodating space. The scraper blade 152 includes a rotating portion 1521 and a scraper portion 1522. The rotating portion 1521 is rotatably mounted on the lower cover 1512. The rotating portion 1521 and a portion of the scraper portion 1522 are located in the accommodating space. The scraper portion 1522 is exposed out of the lower cover 1512 through the bevel slot 1512A. The scraper blade 152 can rotate within a range of the bevel slot 1512A, which means that the bevel slot 1512A further has a function of limiting a rotation range of the scraper blade 152. It can be understood that an elastic pad (not shown) made of an elastic material can be further arranged at a front end of the scraper blade portion 1522, which is not only beneficial for protecting the screen protector plate assembly 200 and avoiding creases or blade lines generated in the screen protector plate assembly 200, but also can increase the friction between the scraper blade 152 and the screen protector plate assembly 200, enhance the squeezing effect of the scraper blade 152, and further avoid bubbles between the screen protector plate and an electronic device. In this embodiment, the elastic member 153 is a torsion spring. The elastic member 153 is nested in the rotating portion 1521. One end of the elastic member 153 resists against the lower cover 1512, and the other end resists against the scraper blade portion 1522. It can be understood that during the sticking of the screen protector, the scraper blade 152 presses the screen protector plate assembly 200. In this case, the elastic member 153 is under force.

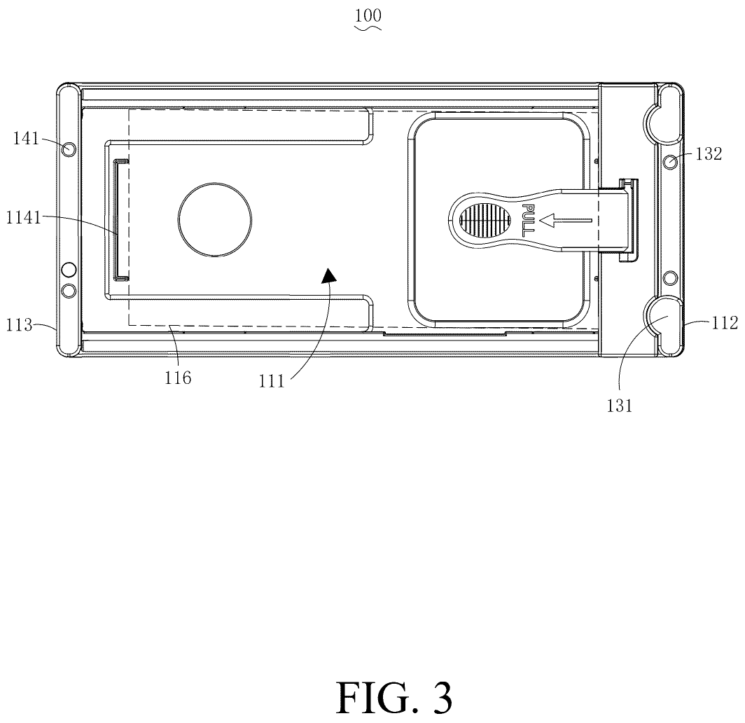

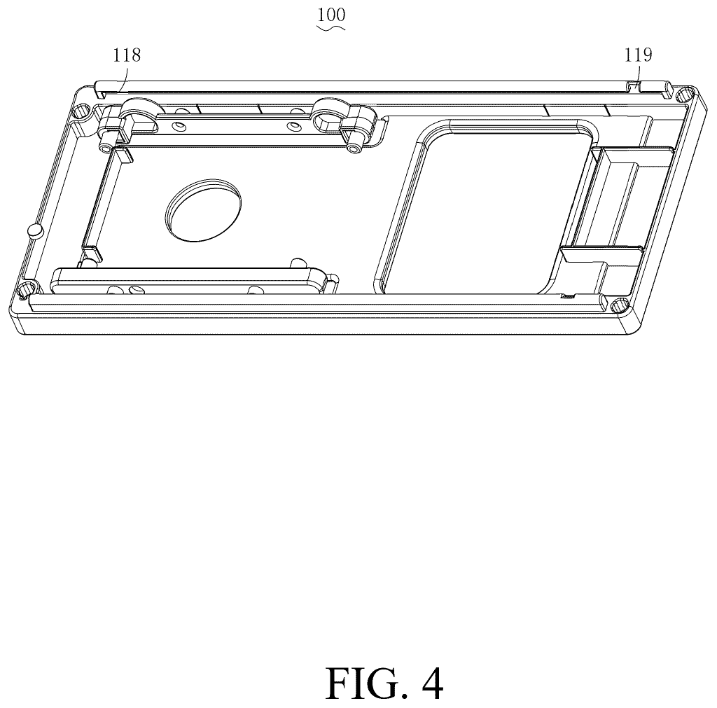

Referring to FIG.2, FIG. 3, and FIG. 4, two locating portions 114 are further arranged in the accommodating chamber 111. A locating slot 1141 is formed on each locating portion 114, and a locating block (not shown) is mounted in the locating slot 1141. In this embodiment, there are two locating portions 114 which are respectively arranged close to the first end 112 and the second end 113, to fix the mobile phone during the sticking of the screen protector. It can be understood that there are also two locating blocks. The locating blocks are made of an elastic material such as silica gel, which is conducive to protecting the mobile phone and preventing the mobile phone from being scratched or damaged. A width of each locating block can be freely selected. A user can mount a locating block with an appropriate size according to a specific size of the mobile phone, which is conducive to improving the applicability of the screen protector sticking tool 100.

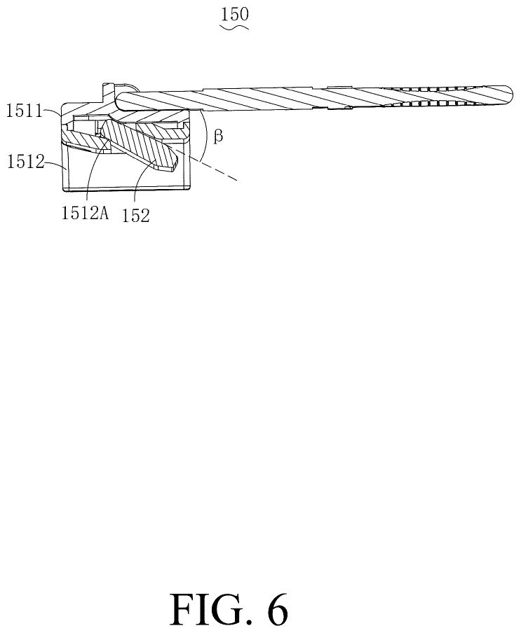

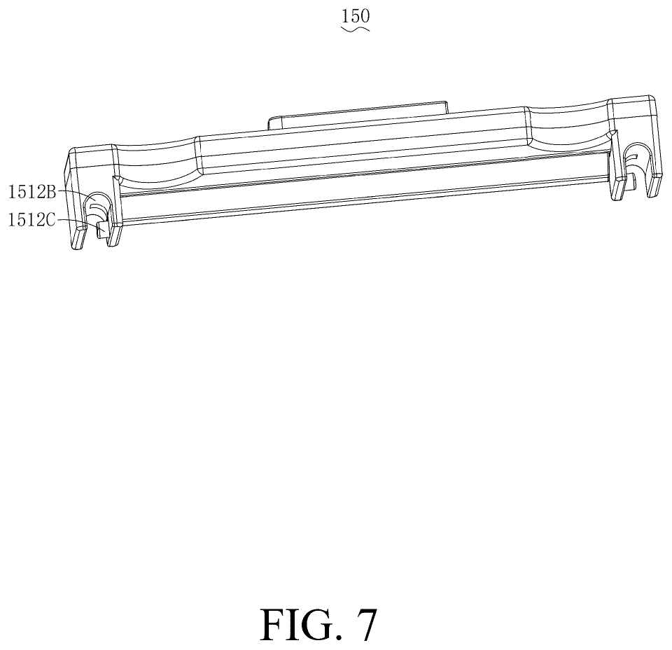

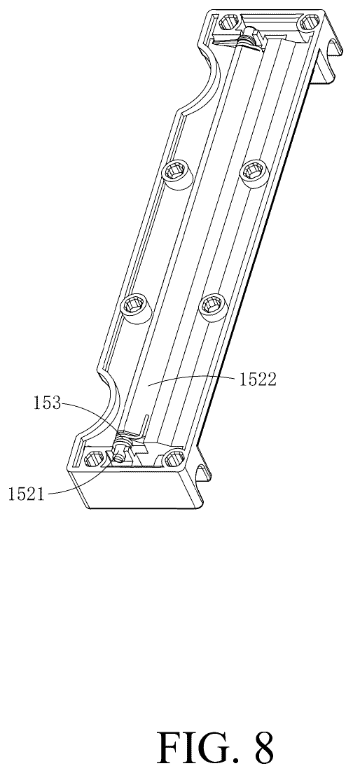

Referring to FIG. 6, FIG. 7, and FIG. 8, according to the screen protector sticking tool 100 of the present disclosure, the scraper blade 152 is oblique relative to the sliding cover 151; the angle of the scraper blade 152 can be adjusted, so that the scraper blade can rotate within a range; and the angle of the scraper blade 152can be adaptively adjusted according to a thickness of the electronic device and a thickness of the screen protector plate when the scraper blade 152 is used in conjunction with a spring, thereby achieving the objective of adjusting the height position of the scraper blade 152. The screen protector sticking tool 100 of the present disclosure is applicable to any type of devices and screen protector plates, and ensures close fit between the scraper blade 152 and the screen protector plate, as well as the electronic device, which is conductive to improving close fit between the screen protector plate and the electronic device, without generating gaps and bubbles.

Referring to FIG. 6, FIG. 7, and FIG. 8, in a possible implementation, an angle β between the scraper blade 152 and an upper end surface of the sliding cover 151 is within a range of [25°, 45°]. Exemplarily, the purpose of tilting the scraper blade 152 is to simulate a manual screen protector sticking process, so that the scraper blade 152 is pushed forwards in a screen protector sticking direction, thereby squeezing out air between the screen protector plate assembly 200 and the electronic device. Bubbles will not be generated, and the screen protector sticking effect is good. It can be understood that the scraper blade 152 is oblique towards the pressing assembly 150 in a sliding direction of the main body piece 110. Namely, when closer to a bottom of the accommodating chamber 111, the scraper blade 152 is closer to the second end 113. In this embodiment, the scraper blade 152 can rotate within a range of 25° to 45°, and the height position of the front end of the scraper blade 152 can be adjusted by the rotation of the scraper blade 152 to adapt to different mobile phones with different thicknesses and screen protector plates with different thicknesses.

Referring to FIG. 2, FIG. 3, and FIG. 4, in a possible implementation, the sliding cover 151 includes a mounting slot 1512B; a protruding column 1512C extends out of the mounting slot 1512B. The main body piece 110 further includes a sliding chute 118 and an inlet slot 119 communicated to the sliding chute 118. The protruding column 1512C enters the sliding chute 118 through the inlet slot 119 and cooperates with the sliding chute 118. Exemplarily, the sliding chute 118 extends from the first end 112 to the second end 113. There are two sliding chutes 118 which are respectively arranged on two opposite sides of the main body piece 110. It can be understood that there are two protruding columns 1512C which respectively cooperate with the two sliding chutes 118. The protruding column 1512C and the sliding chute 118 have a guide effect, which can guide the pressing assembly 150 to slide along a predetermined trajectory. It is beneficial to ensure that the pressing assembly 150 will not slide up and down or left and right during sliding, thereby avoiding non-uniform pressure applied by the pressing assembly 150 to the screen protector plate assembly 200 during the screen protector sticking process.

Referring to FIG. 6, FIG. 7, and FIG. 8, in a possible implementation, the pressing assembly 150 further includes a pull handle 154. The pull handle 154 is rotatably connected to the sliding cover 151. Exemplarily, the function of the pull handle 154 is to facilitate a user to pull the pressing assembly 150 through the pull handle 154. The upper cover 1511 is provided with a rotating slot 1511A and a stopper 1511B, and the stopper 1511B protrudes out of a lateral side of the rotating slot 1511A. The pull handle 154 is rotatably connected to the upper cover 1511 through the rotating slot 1511A, and the pull handle 154 is mounted on one side facing away from the lower cover 1512. The function of the stopper 1511B is to limit a rotation range of the pull handle 154. Specifically, in this embodiment, a maximum angle that can be formed between the pull handle 154 and the upper cover 1511 is 90°. The setting of the stopper 1511B is conducive to ensuring that the pressing assembly 150 can only be pulled in one direction and avoiding such a phenomenon that the pull handle 154 is rotated in an opposite direction, and a user pulls the pressing assembly 150 from the opposite direction. In addition, antiskid raised lines can be set on the pull handle 154 to increase the friction between the hand of the user and the pull handle 154, facilitating the operation by the user.

Referring to FIG. 2, FIG. 3, and FIG. 4, in a possible implementation, the main body piece 110 further includes a placement slot 115 communicated to the accommodating chamber 111; the placement slot 115 is arranged close to the first end 112; the accommodating chamber 111 is provided with a placement region 116 for placing the electronic device; and a ratio of an orthographic projection area of the placement slot 115 to an orthographic projection area of the placement region 116 is not less than 40%. Exemplarily, the purpose of the placement slot 115 is to accommodate a rear camera of a mobile phone. The reason for limiting the ratio of the area of the placement slot 115 to the area of the placement region 116 is to ensure that a slot opening of the placement slot 115 is large enough to accommodate any mobile phone on the market, thereby improving the compatibility of the screen protector sticking tool 100 of the present disclosure. In this embodiment, the placement slot 115 is rectangular. Of course, in specific applications, the shape of the placement slot 115 is not limited to this. For example, as an alternative, the placement slot may alternatively be trapezoidal, circular, or in other irregular shapes. Specifically, the ratio of the orthographic projection area of the placement slot 115 to the orthographic projection area of the placement region 116 can be 40%, 45%, 50%, 55%, or 60%, without excessive limitations here.

Referring to FIG. 2, FIG. 3, and FIG. 4, in a possible implementation, the main body piece 110 further includes a through slot 117 communicated to the accommodating chamber 111; and the through slot 117 is arranged close to the second end 113. Exemplarily, the function of the through slot 117 is to allow a user to reach into the through slot 117 with the fingers to take out the mobile phone after the sticking of the screen protector to the mobile phone is completed. It can be understood that the size of the through slot 117 should be larger than that of the fingers, so that the user can reach into the through slot with the fingers. In this embodiment, the through slot 117 is circular. Of course, in specific applications, the shape of the through slot 117 is not limited to this. For example, as an alternative, the through slot 117 may alternatively be set to be elliptical, rectangular, trapezoidal, or in other irregular shapes.

Referring to FIG. 2, FIG. 3, and FIG. 4, in a possible implementation, the sliding cover 151 includes an fool-proof slot 1513, and the front locating piece 130 is provided with a fool-proof protrusion 131 that cooperates with the fool-proof slot 1513. Exemplarily, in this embodiment, there are two fool-proof slots 1513, and the fool-proof slots 1513 are semi-circular. It can be understood that the shape and number of the fool-proof protrusions 131 are the same as those of the fool-proof slots 1513. By cooperation with the fool-proof slot 1513 and the fool-proof protrusion 131, the front locating piece 130 will not be mounted inversely. If the front locating piece is mounted inversely, the pressing assembly 150 cannot be mounted on the main body piece 110.

Referring to FIG. 2, FIG. 3, and FIG. 4, in a possible implementation, both the front locating piece 130 and the rear locating piece 140 are detachably connected to the main body piece 110; two first locating columns 132 are arranged on the front locating piece 130; two second locating columns 141 are arranged on the rear locating piece 140; and a distance between the two first locating columns 132 is different from a distance between the two second locating columns 141. Exemplarily, the front locating piece 130 and the rear locating piece 140 are detachably connected to facilitate packaging and shipping. As shown in FIG. 4, when it is necessary to package and ship the screen protector sticking tool 100 of the present disclosure, the front locating piece 130, the rear locating piece 140, and the pressing assembly 150 are removed from the main body piece 110, and the front locating piece 130, the rear locating piece 140, and the pressing assembly 150 are placed in the accommodating chamber 111, so that the overall height of the screen protector sticking tool 100 is reduced, which is conductive to saving the space. When the screen protector sticking tool 100 needs to be used, the front locating piece 130 and the rear locating piece 140 are then mounted onto the main body piece 110. Of course, in specific applications, the front locating piece 130 and the rear locating piece 140 can alternatively be integrally formed with the main body piece 110.

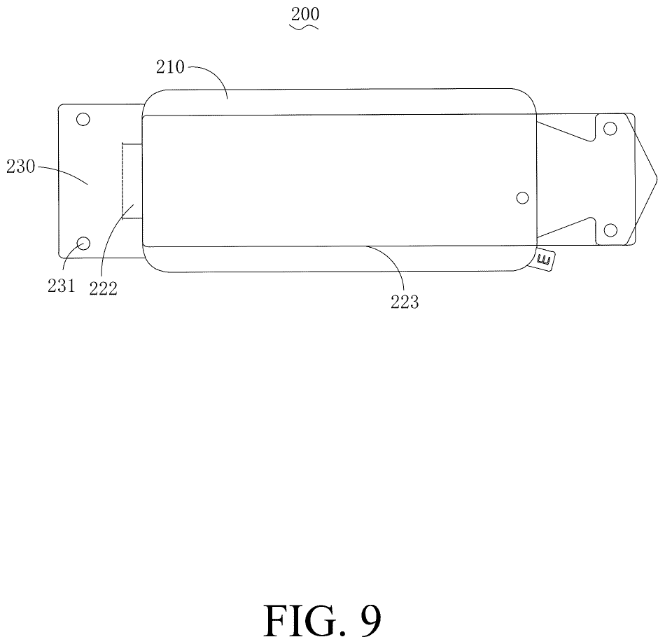

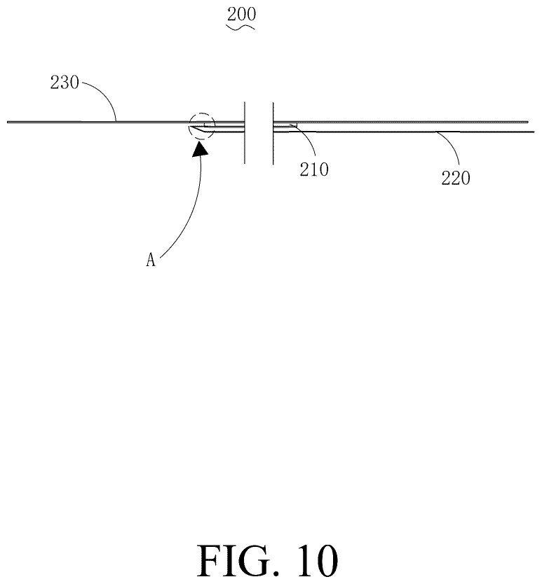

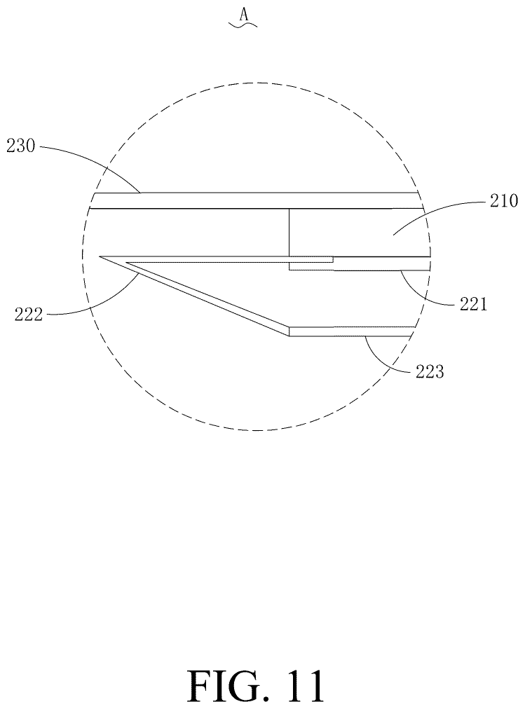

Referring to FIG. 9, FIG. 10, and FIG. 11, a third objective of the present disclosure is to provide a screen protector plate assembly 200 for use with the aforementioned screen protector sticking tool 100, including a main body film 210, a screen protector 220, and a locating film 230. The screen protector 220 includes a sticky portion 221, a connecting portion 222, and a pull handle portion 223; the sticky portion 221 is stuck to a first side of the main body film 210; the pull handle portion 223 and the sticky portion 221 are connected by the connecting portion 222; a width of the connecting portion 222 is less than half of a width of the sticky portion 221; the connecting portion 222 has a crease; and the pull handle portion 223 extends out of the sticky portion 221 from the connecting portion 222. The locating film 230 is attached to a second side of the main body film 210; and the locating film 230 is provided with locating holes that cooperate with the front locating piece 130 and the rear locating piece 140 respectively. Exempplarily, a thickness of the connecting portion 222 is less than a thickness of the sticky portion 221 and a thickness of the pull handle portion 223, and the width is also less than half of the width of the sticky portion 221. The crease is set in the connecting portion 222 to make it easier for the connecting portion 222 to deform; and a unit contact area between the connecting portion 222 and the sticky portion 221 is smaller, making it easier for a user to tear down the sticky portion 221 through the pull handle portion 223. Meanwhile, the connecting portion 222 is partially embedded in the sticky portion 221 and is arranged at a middle position of the sticky portion 221, which further facilitates the separation of the sticky portion 221 from the main body film 210. The main body film 210 may be a soft thermoplastic elastomer (TPE) film, a flexible thermoplastic polyurethane (TPU) film, a flexible epoxy polyurethane (EPU) film, a flexible polyethylene terephthalate (PET) film, and another transparent, peep-proof, colorful, anti-blue ray, or AR anti-reflection non-glass flexible film.

The foregoing embodiments merely express several implementations of the present disclosure. The descriptions thereof are relatively specific and detailed, but are not understood as limitations on the scope of the present disclosure. It should be pointed out that a person of ordinary skill in the art can also make several transformations and improvements without departing from the idea of the present disclosure. These transformations and improvements fall within the protection scope of the present disclosure. Therefore, the protection scope of the patent of the present disclosure shall be subject to the appended claims.

What is claimed is:

1. A screen protector sticking method, comprising the following steps:
S1: placing an electronic device in a screen protector sticking tool;
S2: locating a screen protector plate assembly on the screen protector sticking tool to enable the screen protector plate assembly to be in a tight state, wherein a gap is reserved between the screen protector plate assembly and the electronic device, and a pull handle portion of the screen protector plate assembly is arranged close to the electronic device;
S3: pulling the pull handle portion to flip over the screen protector, and separating the screen protector from a main body film in a direction from a first end towards a second end;
S4: pulling the pressing assembly to press the screen protector plate assembly, so as to move the pressing assembly from the first end to the second end; and
S5: peeling off a locating film, and taking out the electronic device.

2. A screen protector sticking tool, applied to the screen protector sticking method according to claim 1, wherein the screen protector sticking tool comprises:
a main body piece, comprising an accommodating chamber, a first end, and a second end, wherein the accommodating chamber is configured to accommodate the electronic device;
a front locating piece, connected to the main body piece and arranged at the first end;
a rear locating piece, connected to the main body piece and arranged at the second end; and
a pressing assembly, wherein the pressing assembly comprises a sliding cover, a scraper blade, and an elastic member; the sliding cover is slidably connected to the main body piece; the scraper blade is rotatably connected to the sliding cover; the scraper blade is oblique relative to the sliding cover and gradually moves away from the first end in a direction from the sliding cover towards the main body piece; and the elastic member is arranged between the sliding cover and the scraper blade to adaptively adjust a height position of the scraper blade.

3. The screen protector sticking tool according to claim 2, wherein the sliding cover comprises a mounting slot; a protruding column extends out of the mounting slot; the main body piece further comprises a sliding chute and an inlet slot communicated to the sliding chute; the protruding column enters the sliding chute through the inlet slot; and the protruding column cooperates with the sliding chute.

4. The screen protector sticking tool according to claim 3, wherein the pressing assembly further comprises a pull handle, and the pull handle is rotatably connected to the sliding cover.

5. The screen protector sticking tool according to claim 2, wherein the main body piece further comprises a placement slot communicated to the accommodating chamber; the placement slot is arranged close to the first end; the accommodating chamber is provided with a placement region for placing the electronic device; and a ratio of an orthographic projection area of the placement slot to an orthographic projection area of the placement region is not less than 40%.

6. The screen protector sticking tool according to claim 5, wherein the main body piece further comprises a through slot communicated to the accommodating chamber; and the through slot is arranged close to the second end.

7. The screen protector sticking tool according to claim 2, wherein the sliding cover comprises a fool-proof slot; and the front locating piece is provided with a fool-proof protrusion that cooperates with the fool-proof slot.

8. The screen protector sticking tool according to claim 2, wherein both the front locating piece and the rear locating piece are detachably connected to the main body piece; two first locating columns are arranged on the front locating piece; two second locating columns are arranged on the rear locating piece; and a distance between the two first locating columns is different from a distance between the two second locating columns.

9. The screen protector sticking tool according to claim 2, wherein an angle between the scraper blade and an upper end surface of the sliding cover is within a range of [25°, 45°].

10. A screen protector plate assembly, used with the screen protector sticking tool according to claim 2, comprising:
a main body film;
a screen protector, comprising a sticky portion, a connecting portion, and a pull handle portion, wherein the sticky portion is stuck to a first side of the main body film; the pull handle portion and the sticky portion are connected by the connecting portion; a width of the connecting portion is less than half of a width of the sticky portion; the connecting portion has a crease; and the pull handle portion extends out of the sticky portion from the connecting portion; and
a locating film, wherein the locating film is attached to a second side of the main body film; and the locating film is provided with locating holes that cooperate with the front locating piece and the rear locating piece respectively.

11. A screen protector plate assembly, used with the screen protector sticking tool according to claim 3, comprising:
a main body film;
a screen protector, comprising a sticky portion, a connecting portion, and a pull handle portion, wherein the sticky portion is stuck to a first side of the main body film; the pull handle portion and the sticky portion are connected by the connecting portion; a width of the connecting portion is less than half of a width of the sticky portion; the connecting portion has a crease; and the pull handle portion extends out of the sticky portion from the connecting portion; and
a locating film, wherein the locating film is attached to a second side of the main body film; and the locating film is provided with locating holes that cooperate with the front locating piece and the rear locating piece respectively.

12. A screen protector plate assembly, used with the screen protector sticking tool according to claim 4, comprising:
a main body film;
a screen protector, comprising a sticky portion, a connecting portion, and a pull handle portion, wherein the sticky portion is stuck to a first side of the main body film; the pull handle portion and the sticky portion are connected by the connecting portion; a width of the connecting portion is less than half of a width of the sticky portion; the connecting portion has a crease; and the pull handle portion extends out of the sticky portion from the connecting portion; and
a locating film, wherein the locating film is attached to a second side of the main body film; and the locating film is provided with locating holes that cooperate with the front locating piece and the rear locating piece respectively.

13. A screen protector plate assembly, used with the screen protector sticking tool according to claim 5, comprising:
a main body film;
a screen protector, comprising a sticky portion, a connecting portion, and a pull handle portion, wherein the sticky portion is stuck to a first side of the main body film; the pull handle portion and the sticky portion are connected by the connecting portion; a width of the connecting portion is less than half of a width of the sticky portion; the connecting portion has a crease; and the pull handle portion extends out of the sticky portion from the connecting portion; and
a locating film, wherein the locating film is attached to a second side of the main body film; and the locating film is provided with locating holes that cooperate with the front locating piece and the rear locating piece respectively.

14. A screen protector plate assembly, used with the screen protector sticking tool according to claim 6, comprising:
a main body film;
a screen protector, comprising a sticky portion, a connecting portion, and a pull handle portion, wherein the sticky portion is stuck to a first side of the main body film; the pull handle portion and the sticky portion are connected by the connecting portion; a width of the connecting portion is less than half of a width of the sticky portion; the connecting portion has a crease; and the pull handle portion extends out of the sticky portion from the connecting portion; and
a locating film, wherein the locating film is attached to a second side of the main body film; and the locating film is provided with locating holes that cooperate with the front locating piece and the rear locating piece respectively.

15. A screen protector plate assembly, used with the screen protector sticking tool according to claim 7, comprising:
a main body film;
a screen protector, comprising a sticky portion, a connecting portion, and a pull handle portion, wherein the sticky portion is stuck to a first side of the main body film; the pull handle portion and the sticky portion are connected by the connecting portion; a width of the connecting portion is less than half of a width of the sticky portion; the connecting portion has a crease; and the pull handle portion extends out of the sticky portion from the connecting portion; and
a locating film, wherein the locating film is attached to a second side of the main body film; and the locating film is provided with locating holes that cooperate with the front locating piece and the rear locating piece respectively.

16. A screen protector plate assembly, used with the screen protector sticking tool according to claim 8, comprising:
a main body film;
a screen protector, comprising a sticky portion, a connecting portion, and a pull handle portion, wherein the sticky portion is stuck to a first side of the main body film; the pull handle portion and the sticky portion are connected by the connecting portion; a width of the connecting portion is less than half of a width of the sticky portion; the connecting portion has a crease; and the pull handle portion extends out of the sticky portion from the connecting portion; and
a locating film, wherein the locating film is attached to a second side of the main body film; and the locating film is provided with locating holes that cooperate with the front locating piece and the rear locating piece respectively.

17. A screen protector plate assembly, used with the screen protector sticking tool according to claim 9, comprising:
a main body film;
a screen protector, comprising a sticky portion, a connecting portion, and a pull handle portion, wherein the sticky portion is stuck to a first side of the main body film; the pull handle portion and the sticky portion are connected by the connecting portion; a width of the connecting portion is less than half of a width of the sticky portion; the connecting portion has a crease; and the pull handle portion extends out of the sticky portion from the connecting portion; and
a locating film, wherein the locating film is attached to a second side of the main body film; and the locating film is provided with locating holes that cooperate with the front locating piece and the rear locating piece respectively.
